(19) United States
(12) Patent Application Publication
(10) Pub. No.: US 2026/0189027 A1
(43) Pub. Date: Jul. 2, 2026

(54) SOLAR POWER SUPPLY CIRCUIT AND ENVIRONMENTAL DETECTION DEVICE

(71) Applicant: Fujian Tiancheng Baode Intelligent Technology Co., Ltd., Fuzhou (CN)

(72) Inventors: ZHONGDONG HUANG, Fuzhou (CN); JIE YANG, Fuzhou (CN)

(21) Appl. No.: 19/033,425

(22) Filed: Jan. 21, 2025

(30) Foreign Application Priority Data
Dec. 27, 2024 (CN) 202411945767.1

(51) Int. Cl. H02J 7/35; H02J 7/00; H02J 7/34

(52) U.S. Cl. CPC H02J 7/35; H02J 7/345; H02J 7/855; H02J 2207/50

(57) ABSTRACT

A solar power supply circuit and an environmental detection device are provided, the circuit includes a solar panel, an energy storage capacitor, a first low voltage detection chip, a voltage stabilization unit, and a processor chip. A positive terminal and a negative terminal of the solar panel are respectively electrically connected to two ends of the energy storage capacitor. The positive terminal of the solar panel is electrically connected to an input terminal of the first low voltage detection chip, an output terminal of the first low voltage detection chip is electrically connected to an input terminal of the voltage stabilization unit, an output terminal of the voltage stabilization unit is electrically connected to a positive electrode of a power supply of the processor chip. A problem of taking a longer time to enter a normal operation when the existing solar panel is low power can be solved.

### CROSS-REFERENCE TO RELATED APPLICATIONS

This application claims priority to Chinese Patent Application No. 202411945767.1, filed on Dec. 27, 2024, which is hereby incorporated by reference in its entirety.

### TECHNICAL FIELD

The present disclosure relates to the field of solar powered circuit technologies, and in particular, to a solar power supply circuit and an environmental detection device.

### BACKGROUND

The existing solar energy circuits generally generate electricity through solar panels and store the electrical energy in batteries. Under the same lighting conditions, the size of the solar panel (or solar cell panel) determines the amount of electricity generated by the solar panel. When solar panels are installed on smaller devices such as temperature sensors, air humidity meters, etc., their size is limited, and they cannot generate excessive electricity. At this point, if the circuit needs to be directly driven by the solar panel for operation, due to the low power of the solar panel, the circuit has not yet started working properly. However, circuits that are not working properly will continue to consume electricity, which prolongs the time required for a normal operation. Especially when the battery is out of power, if the battery needs to be charged, it will further prolong the working time of the circuit.

### SUMMARY

Therefore, it is necessary to provide a solar power supply circuit and an environmental detection device to solve the problem of long normal working time when the current solar panel power is low.

To achieve the above objectives, the present disclosure provides a solar power supply circuit, including a solar panel, an energy storage capacitor, a first low voltage detection chip, a voltage stabilization unit, and a processor chip; where a positive terminal and a negative terminal of the solar panel are respectively electrically connected to two ends of the energy storage capacitor; the positive terminal of the solar panel is electrically connected to an input terminal of the first low voltage detection chip; an output terminal of the first low voltage detection chip is electrically connected to an input terminal of the voltage stabilization unit; an output terminal of the voltage stabilization unit is electrically connected to a positive pole of a power supply of the processor chip; the negative terminal of the solar panel, a ground terminal of the first low voltage detection chip, a ground terminal of the voltage stabilization unit, and a negative electrode of the power supply of the processor chip are electrically connected; the first low voltage detection chip is configured to output an electrical energy at an input terminal from an output terminal when it is detected that a voltage at the input terminal is greater than a first voltage preset value; the first voltage preset value is greater than a minimum working voltage of the processor chip.

The present disclosure further provides an environmental detection device, including a housing, a circuit board, an environmental detection sensor, and a display screen; where the circuit board is provided in the housing and is provided with the solar power supply circuit; the solar panel of the solar power supply circuit is provided on the housing, a data detection terminal of the processor chip of the solar power supply circuit is electrically connected to a data terminal of the environmental detection sensor; a data display terminal of the processor chip of the solar power supply circuit is electrically connected to a data terminal of the display screen; the environmental detection sensor and the display screen are provided on the housing; the processor chip is configured to obtain data from the environmental detection sensor and display it on the display screen.

Different from the existing technologies, the above technical solution can store the electricity of the solar panel in a timely manner through the energy storage capacitor. Then, through the first low voltage detection chip, the voltage output is not performed when the voltage stored in the energy storage capacitor of the solar panel has not yet reached the first voltage preset value, to avoid the processor chip being unable to work normally due to low voltage or repeatedly restarting and wasting energy. When the voltage of the energy storage capacitor reaches the first voltage preset value, the output is performed, so that the processor chip can start working normally immediately, thereby reducing the time required to enter a normal operation. This prevents the processor chip from consuming the power of the solar panel when the voltage does not reach the working voltage and solving a problem of the existing solar panel entering normal operation for a long time when the power is low.

### BRIEF DESCRIPTION OF DRAWINGS

FIG. 1 is a first circuit diagram according to an embodiment.

FIG. 2 is a second circuit diagram according to the embodiment.

FIG. 3 is a third circuit diagram according to the embodiment.

FIG. 4 is a fourth circuit diagram according to the embodiment.

FIG. 5 is a circuit diagram of a processor chip according to an embodiment.

### DESCRIPTION OF EMBODIMENTS

To provide a detailed explanation of the technical content, structural features, achieved goals, and effects of the technical solution, the following will be explained in combination with specific embodiments and accompanying drawings.

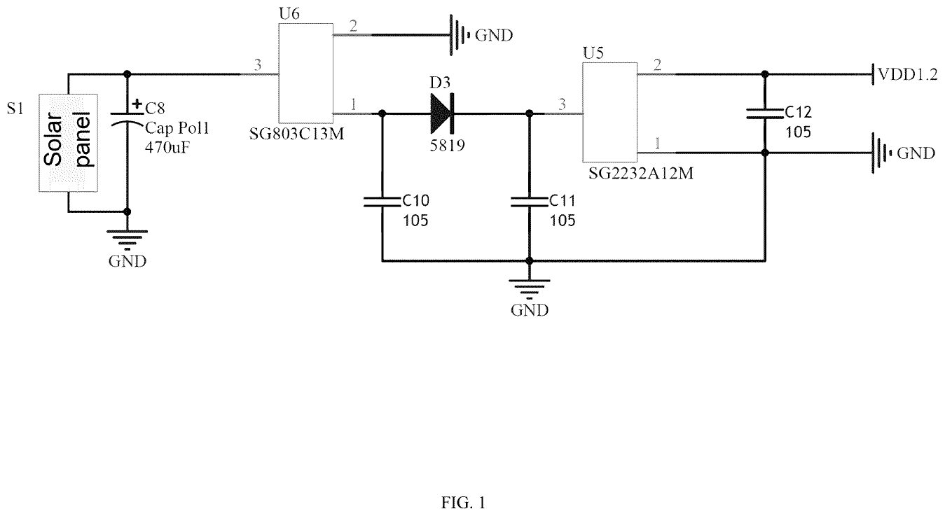

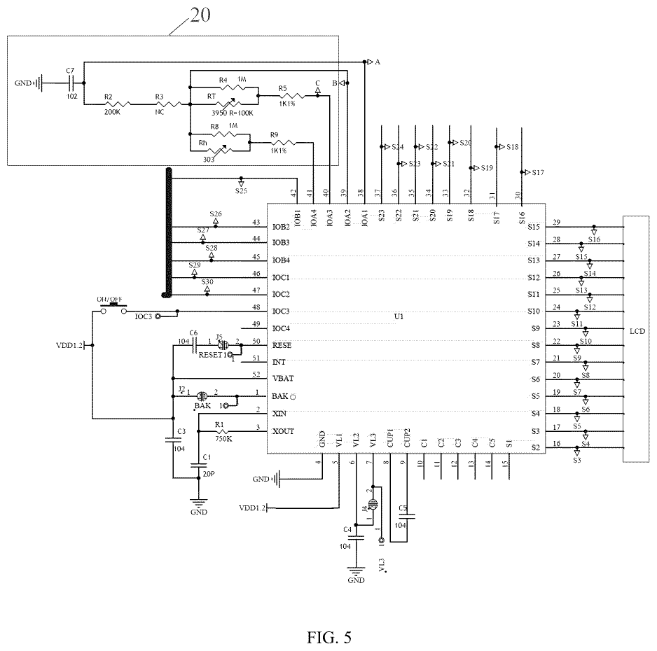

Please refer to FIG. 1. The present disclosure provides a solar power supply circuit, including a solar panel S1, an energy storage capacitor C8, a first low voltage detection chip U6, a voltage stabilization unit U5, and a processor chip U1. A positive terminal and a negative terminal of the solar panel S1 are electrically connected to two ends of the energy storage capacitor C8, the positive terminal of the solar panel S1 is electrically connected to an input terminal of the first low voltage detection chip U6, an output terminal of the first low voltage detection chip U6 is electrically connected to an input terminal of the voltage stabilization unit U5, an output terminal of the voltage stabilization unit U5 is electrically connected to a positive electrode of a power supply of the processor chip; the negative terminal VDD of the solar panel S1, a ground terminal of the first low voltage detection chip U6, a ground terminal of the voltage stabilization unit U5, and a positive electrode of the power supply of the processor chip are electrically connected. The first low voltage detection chip U6 is configured to output an electrical energy at an input terminal from an output terminal when it is detected that a voltage at the input terminal is greater than a first voltage preset value, the first voltage preset value is greater than a minimum working voltage of the processor chip.

Where, the solar panel S1 is configured to convert solar energy into electrical energy for output. The energy storage capacitor C8 can immediately store the electrical energy of the solar panel S1. The first low voltage detection chip U6 is configured to detect the voltage at the input terminal (i.e. a voltage of the energy storage capacitor C8) is greater than the first voltage preset value, and then output the electrical energy at the input terminal from the output terminal. After the output terminal of the first low voltage detection chip U6 outputs the electrical energy, the voltage stabilization unit U5 starts working and outputs a stable voltage to the processor chip U1 for use. As shown in FIGS. 1 and 5, the voltage stabilization unit U5 outputs a voltage VDD1.2 to the processor chip U1 for use. The voltage stabilization unit can be an LDO voltage stabilization chip or a DC-DC voltage stabilization chip, in an implementation mode, it is the LDO voltage stabilization chip shown in the figure. The processor chip U1 is a programmable chip, such as an MCU. It should be noted that the minimum working voltage of the processor chip refers to a minimum voltage at which the processor chip can start and run stably, such as 1.2V. The first voltage preset value needs to be at least greater than the minimum working voltage, which can be 1.3V or a higher voltage, such as 1.5V. In this way, the voltage stabilization unit U5 can output a voltage that meets the minimum working voltage of the processor chip, so that the processor chip U1 can work normally. In this way, when the voltage stored in the energy storage capacitor of the solar panel has not yet reached the first voltage preset value, voltage output is not performed to avoid too low voltage that cannot make the processor chip U1 work normally and waste electricity. Then, when the voltage of the energy storage capacitor reaches the first voltage preset value, output is performed, so that the processor chip can start working normally immediately, thereby reducing the time required to enter a normal operation. This prevents the processor chip from consuming the power of the solar panel when the voltage does not reach the working voltage, and solving a problem that a long time for the existing solar panel to enter the normal operation when the power is low.

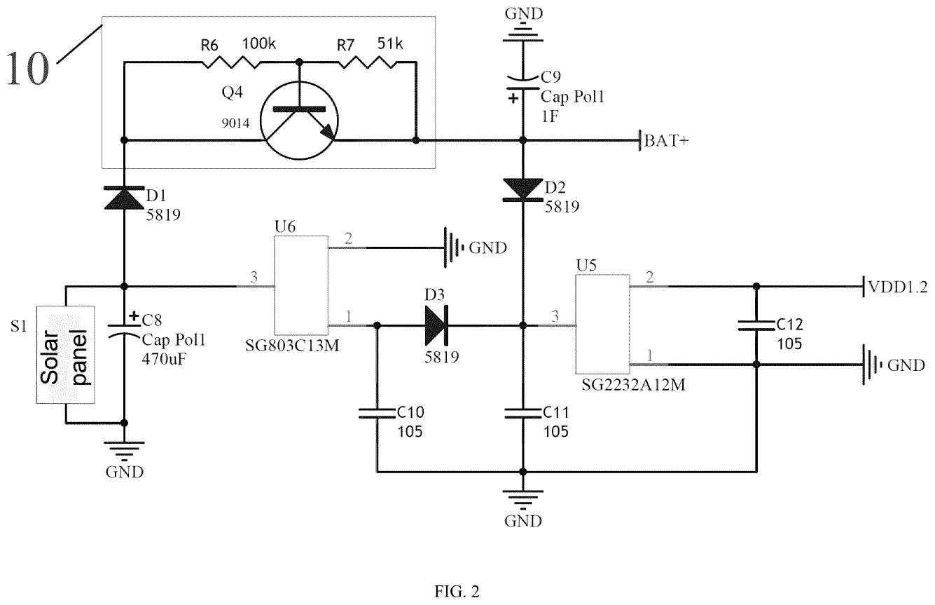

The above embodiments can directly provide the electrical energy of the solar panel to the processor chip U1 for operation. In an implementation mode, excess electrical energy from the solar panels can also be stored. As shown in FIG. 2, the solar power supply circuit further includes a first diode D1, a second diode D2, a third diode D3, a charging control unit 10, and an energy storage unit. An electrical connection between the output terminal of the first low voltage detection chip U6 and the input terminal of the voltage stabilization unit U5 includes: the output terminal of the first low voltage detection chip U6 is electrically connected to a positive terminal of the third diode D3, and a negative terminal of the third diode D3 is electrically connected to the input terminal of the voltage stabilization unit U5. By using the third diode D3, it is possible to avoid a reverse flow of current to the first low voltage detection chip U6 when the solar panel S1 is out of power, thus avoiding the waste of electrical energy caused by a reverse flow of electrical energy. The positive terminal of the solar panel S1 is further electrically connected to a positive terminal of the first diode D1, a negative terminal of the first diode D1 is electrically connected to an input terminal of the charging control unit 10. An output terminal of the charging control unit 10 is electrically connected to a positive terminal of the energy storage unit and a positive terminal of the second diode; a negative terminal of the second diode is electrically connected to the negative terminal of the third diode D3 and the input terminal of the voltage stabilization unit U5. A negative terminal of the energy storage unit is electrically connected to the negative terminal of the solar panel. The charging control unit 10 is configured to control to reduce an electrical energy at an input terminal and a charging current as a voltage at the input terminal is decreased when a voltage at the input terminal is greater than a second voltage preset value. The second voltage preset value is greater than the first voltage preset value, and the energy storage unit is a capacitor C9 or a charging battery BAT+. A capacity of the capacitor C9 can be greater than that of the energy storage capacitor C8 to achieve more energy storage. The rechargeable battery can be a lithium battery, a nickel hydrogen battery, etc., and the charging voltage can be1.5V.

The second voltage preset value is greater than the first voltage preset value, such as 1.5V, so that the circuit of the present disclosure first ensures the operation of the processor chip. Then, after the voltage is high, the charging control unit 10 starts charging. At the same time, the charging control unit 10 can control the charging current to decrease as the voltage at the input terminal is decreased. Therefore, when the voltage of the solar panel S1 is still relatively low, the charging current is small to avoid excessive energy loss. Then, when the voltage of the solar panel S1 is still relatively high, the charging current is larger, which can charge more electricity to the energy storage unit. Then, when the solar panel S1 runs out of power and the energy storage unit has power, the electricity from the energy storage unit can flow from the second diode to the voltage stabilization unit U5, thereby achieving power supply from the energy storage unit to the processor chip U1. This embodiment ensures that excess power can be stored in the energy storage unit, and also ensures that when the power of the solar panel S1 is low, priority is given to supplying power to the processor chip to ensure its operation.

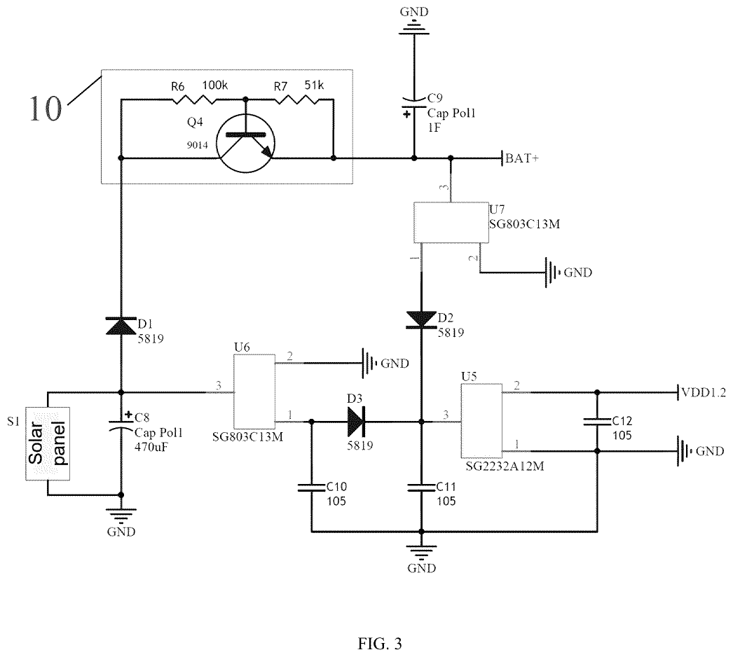

Furthermore, in order to avoid the possibility that the voltage of the energy storage unit being too low when used alone, which may cause the processor chip to be not in a normal working state. As shown in FIG. 3, based on FIG. 2, the present disclosure further includes a second low voltage detection chip U7. An electrical connection between the output terminal of the charging control unit 10 with the positive terminal of the energy storage unit and the positive terminal of the second diode D2 includes: the output terminal of the charging control unit 10 is electrically connected to the positive terminal of the energy storage unit and an input terminal of the second low voltage detection chip U7, and an output terminal of the second low voltage detection chip U7 is electrically connected to the positive terminal of the second diode D2, a ground terminal of the second low voltage detection chip U7 is electrically connected to the negative terminal of the solar panel S1. The second low voltage detection chip U7 can be the same chip as the first low voltage detection chip. In this way, the low voltage detection chip can ensure that power is only provided to the voltage stabilization unit after the voltage of the energy storage unit is greater than the first preset voltage value, and then used by the processor chip. It can ensure the normal operation of the processor chip when using the energy storage unit alone, thereby avoiding a situation where the processor chip cannot function properly due to low voltage and consuming electricity.

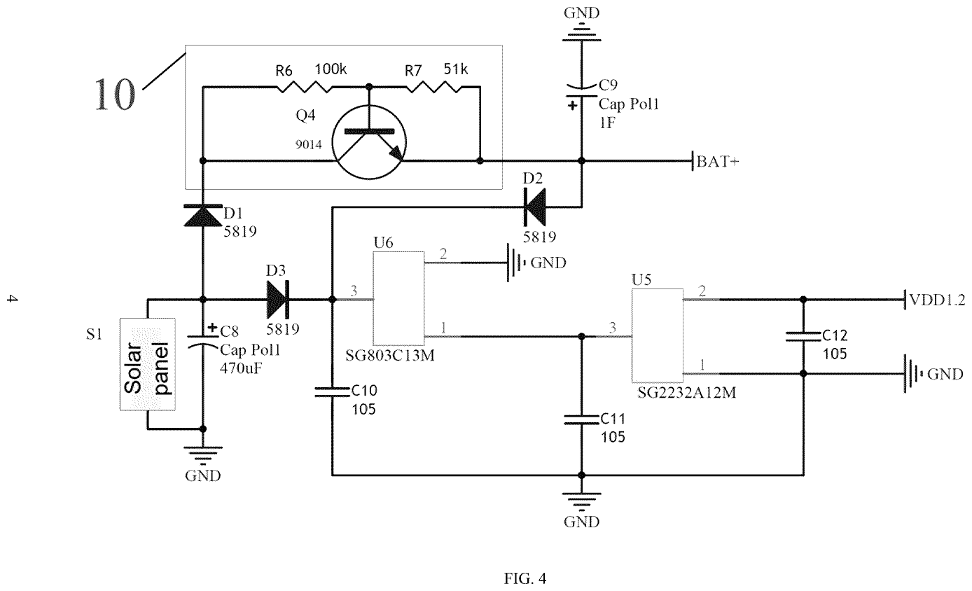

Furthermore, as shown in FIG. 4, in order to store the excess electrical energy of the solar panel, the present disclosure further includes a first diode D1, a second diode D2, a third diode D3, a charging control unit 10, and an energy storage unit. An electrical connection between the positive terminal of the solar panel S1 and the input terminal of the first low voltage detection chip U6 includes: the positive terminal of the solar panel S1 is electrically connected to a positive terminal of the third diode D3, a negative terminal of the third diode D3 is electrically connected to the input terminal of the first low voltage detection chip U6; the positive terminal of the solar panel S1 is further electrically connected to a positive terminal of first diode D1, a negative terminal of the first diode D1 is electrically connected to an input terminal of the charging control unit 10, the output terminal of the charging control unit 10 is electrically connected to the positive terminal of the energy storage unit and a positive terminal of second diode D2; a negative terminal of the second diode D2 is electrically connected to a negative terminal of the third diode and the input terminal of the first low voltage detection chip U6, and the negative terminal of the energy storage unit is electrically connected to the negative terminal of the solar panel. The charging control unit 10 is configured to control to reduce an electrical energy at an input terminal and a charging current as a voltage at the input terminal is decreased when a voltage at the input terminal is greater than a second voltage preset value. The second voltage preset value is greater than the first voltage preset value, and the energy storage unit is a capacitor or a rechargeable battery.

In this way, the charging control unit 10 will only start charging after the voltage of the solar panel is high. At the same time, the charging control unit 10 can control the charging current to decrease as the voltage at the input terminal is decreased. Therefore, when the voltage of the solar panel S1 is still relatively low, the charging current is small to avoid excessive energy loss. Then, when the voltage of the solar panel S1 is still relatively high, the charging current is larger, which can charge more electricity to the energy storage unit. Then, when the solar panel S1 runs out of power and the energy storage unit has power, the power of the energy storage unit can flow from the second diode D2 to the first low voltage detection chip and then to the voltage stabilization unit U5, thereby achieving power supply from the energy storage unit to the processor chip U1. This embodiment ensures that excess power can be stored in the energy storage unit, and also ensures that when the power of the solar panel S1 is low, priority is given to supplying power to the processor chip to ensure its operation.

The charging control unit 10 of the present disclosure only needs to meet the control requirements of the present disclosure, and can be implemented using a separate chip or discrete components. As shown in FIGS. 2 to 4, the charging control unit 10 includes an NPN transistor Q4, a first voltage divider resistor R6, and a second voltage divider resistor R7. A collector electrode of the NPN transistor Q4 is electrically connected to one end of the first voltage divider resistor R6 as the input terminal of the charging control unit 10; a base electrode of the NPN transistor Q4 is electrically connected to the other end of the first voltage divider resistor R6 and one end of the second voltage divider resistor R7, and the other end of the second voltage divider resistor R7 is electrically connected to an emitter electrode of the NPN transistor Q4 as the output terminal of the charging control unit 10. At this point, the second voltage preset value of the charging control unit 10 satisfies the following formula: V2=V3*(R1+R2)/R2. V2 is the second voltage preset value, V3 is a turn-on voltage of the NPN transistor, R1 is a resistance value of the first voltage divider resistor R6, and R2 is a resistance value of the second voltage divider resistor R7. When a voltage difference between the input terminal and the output terminal of the charging control unit 10 reaches the turn-on voltage of the NPN transistor Q4 through the voltage divider resistor, charging can be started. As the voltage at the input terminal of the charging control unit 10 increases, the charging current also increases, thereby meeting the requirements of charging control.

Furthermore, as shown in FIG. 1, the solar power supply circuit further includes a third diode D3. The positive terminal of the solar panel S1 is electrically connected to the input terminal of the first low voltage detection chip U6 through the third diode D3, or the output terminal of the first low voltage detection chip U6 is electrically connected to the input terminal of the voltage stabilization unit U5 through the third diode D3. By using the third diode D3, it is possible to avoid the reverse flow of current to the first low voltage detection chip U6 when the solar panel S1 is out of power, thus avoiding the waste of electrical energy caused by the reverse flow of electrical energy.

Furthermore, the solar power supply circuit further includes a monochrome display screen, a temperature sensor or a humidity sensor; a data terminal of the monochrome display screen, the temperature sensor or the humidity sensor is electrically connected to a data terminal of the processor chip U1. The monochrome display screen consumes less power and can meet low-power display requirements, thereby reducing the time required for display.

Furthermore, the energy storage capacitor C8 has a capacity of 200 uf to 1500 uf, in an implementation, has a capacity of 470 uf. In this way, the capacity of the energy storage capacitor is relatively small, which can quickly boost the voltage to reach the voltage required for the processor chip to start. Of course, it should not be too small to avoid a rapid drop in voltage after the first low voltage detection chip is turned on.

In an implementation mode, the processor chip is a low-power chip, and a minimum working current of the processor chip U1 (i.e. a minimum current required for the processor chip to operate) is less than 9 uA; in an implementation mode, it is less than 5 uA. This can achieve fast startup of the processor chip.

In an implementation mode, an area of the solar panel S1 is less than 24 square centimeters (i.e., a size is below 30 mm*80 mm or below 40 mm*50mm), or the size of the solar panel S1 is 38 mm*13 mm, 35 mm*14 mm, 46 mm*16 mm, 55 mm*14 mm, 55 mm*18 mm, or 60 mm*30 mm. The solar panel has a small area and can be used on smaller devices, enabling fast startup of processor chips for smaller devices.

Furthermore, after the processor chip is started, a main program in the processor chip waits for a first preset time before entering a working mode. The main program can be the main program without initializing, driving, or detecting external unit modules connected to the processor chip. After being powered on, waiting for a period can store more electrical energy, thereby avoiding a situation where the voltage drops rapidly due to excessive power consumption caused by starting work at the beginning.

The present disclosure provides an environmental detection device, including a housing, a circuit board, an environmental detection sensor, and a display screen. The circuit board is provided in the housing, and the circuit board is provided with the solar power supply circuit according to any embodiment of the present disclosure. The solar panel S1 of the solar power supply circuit is provided on the housing, a data detection terminal of the processor chip U1 of the solar power supply circuit is electrically connected to a data terminal of the environmental detection sensor, a data display terminal of the processor chip U1 of the solar power supply circuit is electrically connected to a data terminal of the display screen. The environmental detection sensor and the display screen are provided on the housing, and the processor chip U1 is configured to obtain data from the environmental detection sensor and display it on the display screen. The environmental detection sensor can be an environmental detection circuit 20 shown in FIG. 5, which can be a thermal sensor (temperature sensor) or a humidity sensor, such as a thermistor RH or a humidity sensor RT in FIG. 5. After the solar panel receives light, this device outputs when the voltage of the energy storage capacitor reaches the first preset voltage value, so that the processor chip can start working normally immediately, thereby reducing the time required to enter the normal operation and achieving rapid display of environmental parameters.

It should be noted that although the above embodiments have been described in this specification, it does not limit the protection scope of the present disclosure. Therefore, based on the innovative concept of the present disclosure, any changes and modifications made to the embodiments described in this specification, or equivalent structural or process transformations made using the content of this specification and drawings, directly or indirectly applying the above technical solutions to other related technical fields, are all included in the protection scope of the present disclosure.

What is claimed is:

1. A solar power supply circuit, comprising a solar panel, an energy storage capacitor, a first low voltage detection chip, a voltage stabilization unit, and a processor chip;
wherein a positive terminal and a negative terminal of the solar panel are respectively electrically connected to two ends of the energy storage capacitor;
the positive terminal of the solar panel is electrically connected to an input terminal of the first low voltage detection chip;
an output terminal of the first low voltage detection chip is electrically connected to an input terminal of the voltage stabilization unit;
an output terminal of the voltage stabilization unit is electrically connected to a positive pole of a power supply of the processor chip;
the negative terminal of the solar panel, a ground terminal of the first low voltage detection chip, a ground terminal of the voltage stabilization unit, and a negative electrode of the power supply of the processor chip are electrically connected;
the first low voltage detection chip is configured to output an electrical energy at an input terminal from an output terminal when it is detected that a voltage at the input terminal is greater than a first voltage preset value; the first voltage preset value is greater than a minimum working voltage of the processor chip.

2. The solar power supply circuit according to claim 1, further comprising a first diode, a second diode, a third diode, a charging control unit, and an energy storage unit;
an electrical connection between the output terminal of the first low voltage detection chip and the input terminal of the voltage stabilization unit comprises: the output terminal of the first low voltage detection chip is electrically connected to a positive terminal of the third diode, and a negative terminal of the third diode is electrically connected to the input terminal of the voltage stabilization unit;
the positive terminal of the solar panel is further electrically connected to a positive terminal of the first diode, a negative terminal of the first diode is electrically connected to an input terminal of the charging control unit,
an output terminal of the charging control unit is electrically connected to a positive terminal of the energy storage unit and a positive terminal of the second diode,
a negative terminal of the second diode is electrically connected to the negative terminal of the third diode and the input terminal of the voltage stabilization unit,
a negative terminal of the energy storage unit is electrically connected to the negative terminal of the solar panel;
the charging control unit is configured to control to reduce an electrical energy at an input terminal and a charging current as a voltage at the input terminal is decreased when a voltage at the input terminal is greater than a second voltage preset value; the second voltage preset value is greater than the first voltage preset value, and the energy storage unit is a capacitor or a rechargeable battery.

3. The solar power supply circuit according to claim 2, further comprises a second low voltage detection chip;
the output terminal of the charging control unit being electrically connected to the positive terminal of the energy storage unit and the positive terminal of the second diode comprises:
the output terminal of the charging control unit is electrically connected to the positive terminal of the energy storage unit and an input terminal of the second low voltage detection chip; an output terminal of the second low voltage detection chip is electrically connected to the positive terminal of the second diode; a ground terminal of the second low voltage detection chip is electrically connected to the negative terminal of the solar panel.

4. The solar power supply circuit according to claim 1, further comprising a first diode, a second diode, a third diode, a charging control unit, and an energy storage unit;
the positive terminal of the solar panel being electrically connected to the input terminal of the first low voltage detection chip comprises:
the positive terminal of the solar panel is electrically connected to a positive terminal of the third diode, a negative terminal of the third diode is electrically connected to the input terminal of the first low voltage detection chip, and a negative terminal of the energy storage unit is electrically connected to the negative terminal of the solar panel;
the positive terminal of the solar panel is further electrically connected to a positive terminal of the first diode, a negative terminal of the first diode is electrically connected to an input terminal of the charging control unit; an output terminal of the charging control unit is electrically connected to a positive terminal of the energy storage unit and a positive terminal of the second diode; a negative terminal of the second diode is electrically connected to the negative terminal of the third diode and the input terminal of the first low voltage detection chip;
the charging control unit is configured to control to reduce an electrical energy at an input terminal and a charging current as a voltage at the input terminal is decreased when a voltage at the input terminal is greater than a second voltage preset value; the second voltage preset value is greater than the first voltage preset value, and the energy storage unit is a capacitor or a rechargeable battery.

5. The solar power supply circuit according to claim 2, wherein the charging control unit comprises an NPN transistor, a first voltage divider resistor, and a second voltage divider resistor;
a collector electrode of the NPN transistor is electrically connected to one end of the first voltage divider resistor as the input terminal of the charging control unit,
a base electrode of the NPN transistor is electrically connected to the other end of the first voltage divider resistor and one end of the second voltage divider resistor; the other end of the second voltage divider resistor is electrically connected to an emitter electrode of the NPN transistor as the output terminal of the charging control unit.

6. The solar power supply circuit according to claim 1, further comprising a third diode, wherein the positive terminal of the solar panel is electrically connected to the input terminal of the first low voltage detection chip through the third diode, or the output terminal of the first low voltage detection chip is electrically connected to the input terminal of the voltage stabilization unit through the third diode.

7. The solar power supply circuit according to claim 1, further comprising a monochrome display screen, a temperature sensor or a humidity sensor,
a data terminal of the monochrome display screen, the temperature sensor or the humidity sensor is electrically connected to a data terminal of the processor chip.

8. The solar power supply circuit according to claim 1, wherein the energy storage capacitor has a capacity of 200uf to 1500uf, or
a minimum working current of the processor chip is less than 9 uA, or
an area of the solar panel is less than 24 square centimeters.

9. The solar power supply circuit according to claim 1, wherein the energy storage capacitor has a capacity of 470 uf, or
a minimum working current of the processor chip is less than 5 uA, or
the solar panel has a size of 38 mm*13 mm, 35 mm*14mm, 46 mm*16mm, 55 mm*14 mm, 55 mm*18 mm, or 60 mm*30 mm.

10. The solar power supply circuit according to claim 1, wherein after the processor chip is started, a main program in the processor chip waits for a first preset time before entering a working mode.

11. An environmental detection device, comprising a housing, a circuit board, an environmental detection sensor, and a display screen;
wherein the circuit board is provided in the housing and is provided with the solar power supply circuit according to claim 1;
the solar panel of the solar power supply circuit is provided on the housing, a data detection terminal of the processor chip of the solar power supply circuit is electrically connected to a data terminal of the environmental detection sensor;
a data display terminal of the processor chip of the solar power supply circuit is electrically connected to a data terminal of the display screen;
the environmental detection sensor and the display screen are provided on the housing;
the processor chip is configured to obtain data from the environmental detection sensor and display it on the display screen.
